(19) United States
(12) Patent Application Publication
(10) Pub. No.: US 2005/0286202 A1
(43) Pub. Date: Dec. 29, 2005

(54) Electrostatic chuck, device manufacturing apparatus, and device manufacturing method

(75) Inventor: Yoshihiko Nakamura, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/150,112

(22) Filed: Jun. 13, 2005

(30) Foreign Application Priority Data
Jun. 14, 2004 (JP) 175590/2004(PAT.)

(51) Int. Cl. H01T 23/00

(52) U.S. Cl. 361/234

(57) ABSTRACT

Disclosed is an electrostatic chuck as well as a device manufacturing apparatus and a device manufacturing method using such electrostatic chuck. In one preferred form, the present invention provides an electrostatic chuck for holding an object through an electrostatic attraction force, and it includes an electrode, a main body including the electrode, the main body having a first surface for holding the object and a second surface different from the first surface, a protrusion formed on the second surface of the main body, and a terminal provided on the protrusion, for electric conduction with the electrode.

### FIELD OF THE INVENTION AND RELATED ART

This invention relates generally to an electrostatic chuck usable in various device manufacturing apparatuses such as a semiconductor manufacturing apparatus or a liquid crystal manufacturing apparatus, for example, for holding a substrate such as a semiconductor substrate or a liquid crystal glass substrate, for example.

In semiconductor manufacturing apparatuses, in order to avoid deposition of fine particles on a wafer or formation of an oxide film thereupon, a vacuum ambience or nitride gas ambience is maintained between processing machines through which each wafer is conveyed. During transportation, an electrostatic chuck is used to hold the wafer.

Japanese Laid-Open Patent Application, Publication No, 10-189697 shows an example of electrostatic chuck, wherein the chuck has a first attracting electrode for applying a positive electric voltage to the upper surface of an insulative base member and a second attracting electrode for applying a negative electric voltage to the base member, and wherein a dielectric material layer is provided on the upper surface of the insulative base member as an integral coating, the upper surface thereof thus functioning as a holding surface for a wafer or the like. Voltage applying terminals are connected to the attracting electrodes which are accommodated in the electrostatic chuck. DC voltages are applied to them from a high voltage source and through the voltage applying terminals, whereby an electrostatic attraction force is produced between the chuck and the wafer, which attracts and holds the wafer.

In such electrostatic chuck, voltages must be applied to the attracting electrode continuously to keep the electrostatic attraction force. This causes serious inconveniences that the electrostatic shuck has to be fixed to a main frame of the apparatus with an electric voltage source and that, if the electrostatic chuck is to be moved, power supplying wires from the voltage source must be extended throughout the entire conveyance path of the chuck.

An example that may avoid these inconveniences is disclosed in Japanese Laid-Open Patent Application, Publication No. 5-315429 wherein a movable member having an electrostatic chuck is provided with a capacitor and a selector switch and wherein, along the conveyance path of the movable member, voltage applying devices are provided at respective stop positions of the movable member, such that when the movable member is stopped, an electric voltage is supplied to the capacitor and while the movable member is being moved, the voltage is supplied to the electrostatic chuck from the capacitor. This enables movement of the chuck through the conveyance path without the need for extending the electric wires.

In such electrostatic chuck, however, since a capacitor as well as a selector switch for changing the voltage application have to be provided inside the movable member, the movable member becomes bulky and also the structure is very complicated.

There is another problem. An article to be attracted is conveyed by movement of the movable member while being attracted to the electrostatic chuck. Here, since the electrostatic chuck can not be demounted from the movable member, for transfer of the article, the article must be disengaged from the electrostatic chuck. Japanese Laid-Open Patent Application, Publication No. 9-162272 proposes a conveying method wherein an electrostatic chuck is demountably mounted on a holding table through electrostatic attraction and an article is conveyed to a subsequent process while being attracted to the chuck. However, this document does not mention to the possibility of transferring the electrostatic chuck itself.

If there is a structure that enables such chuck conveyance that an article to be attracted such as a wafer, for example, is conveyed and transferred while the article is being attracted to and kept integral with an electrostatic chuck, the time necessary for conveying and transferring the wafer can be reduced significantly. Hence, in a semiconductor manufacturing apparatus wherein extraordinarily high positioning precision is required, the positioning method for electrostatic chuck transfer is a very important matter to be considered.

### SUMMARY OF THE INVENTION

It is accordingly an object of the present invention to provide a unique and improved technique that relates to an electrostatic chuck and that is suitable for chuck conveyance.

In accordance with an aspect of the present invention, there is provided an electrostatic chuck for holding an object through an electrostatic attraction force, comprising: an electrode; a main body including said electrode, said main body having a first surface for holding the object and a second surface different from the first surface; a protrusion formed on the second surface of said main body; and a terminal provided on said protrusion, for electric conduction with said electrode.

In accordance with another aspect of the present invention, there is provided an apparatus for manufacturing a device, said apparatus comprising: an electrostatic chuck as recited in above; and a stage for holding said electrostatic chuck, said stage having a terminal for applying a voltage to a terminal of said electrostatic chuck as recited above.

In accordance with a further aspect of the present invention, there is provided an apparatus for manufacturing a device, said apparatus comprising: an electrostatic chuck as recited above; and a hand for conveying said electrostatic chuck, said hand having a terminal for applying a voltage to a terminal of said electrostatic chuck as recited above.

In accordance with a yet further aspect of the present invention, there is provided a method of manufacturing a device, said method comprising steps of: holding an object by use of an electrostatic chuck as recited above; and processing the object held by the electrostatic chuck, for production of the device.

Briefly, the present invention can provide useful technique suitable for chuck conveyance.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view of a general structure of an electrostatic chuck according to a first embodiment of the present invention.

FIG. 2A is a bottom view of an electrostatic chuck according to the first embodiment of the present invention.

FIG. 2B is a plan view, illustrating the disposition of pinholes on a stage in the first embodiment of the present invention.

FIG. 3 is a schematic view for explaining a voltage applying method in accordance with the first embodiment of the present invention, in a case where an electrostatic chuck is mounted on a stage.

FIG. 4 is a schematic view for explaining engagement between positioning pins and pinholes, constituting kinematic coupling, in the first embodiment of the present invention.

FIG. 5 is a schematic view for explaining a voltage applying method in accordance with the first embodiment of the present invention, in a case where an electrostatic chuck is conveyed by means of a conveying hand.

FIG. 6A is a bottom view of an electrostatic chuck according to a second embodiment of the present invention.

FIG. 6B is a plan view, illustrating the disposition of pinholes on a stage in the second embodiment of the present invention.

FIG. 7 is a schematic view for explaining a voltage applying method in accordance with the second embodiment of the present invention, in a case where an electrostatic chuck is mounted on a stage.

FIG. 8 is a schematic view of an exposure apparatus to which an embodiment of the present invention is applied.

FIG. 9 is a flow chart for explaining general procedure for manufacturing microdevices.

### DESCRIPTION OF THE PREFERRED EMBODIMENTS

Preferred embodiments of the present invention will now be described with reference to the attached drawings.

### Embodiment 1

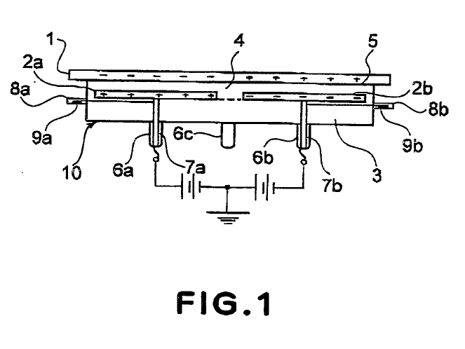

FIG. 1 is a schematic view of a general structure of an electrostatic chuck according to a first embodiment of the present invention. The electrostatic chuck generally denoted at 10 includes an insulating base member 3 as well as a first attracting electrode 2a for applying a positive voltage and a second attracting electrode 2b for applying a negative voltage, these electrodes being provided on the upper surface of the base member 3. A dielectric material layer 4 is provided on the upper surface of the insulative base member 3 to cover these electrodes 2a and 2b as an integral coating. The insulative base member and the dielectric material layer may be called a main body of the electrostatic chuck. The upper surface of the dielectric material layer 4 functions as a holding surface 5 for holding an article 1 by attraction.

The insulating base member 3 is provided with positioning pins 6a, 6b and 6c having rounded or spherical free ends, which are provided on the bottom surface of the base member. Further, on the side surfaces of the insulative base member 3, there are protrusions 8a and 8b which function as holding means when the electrostatic chuck is conveyed. The insulative base member 3 further includes, inside thereof, chuck side voltage applying terminals 7a and 7b each having an end connected to the attracting electrode 2a or 2b and another end extending through the positioning pin 6a or 6b and being exposed from the free end of the positioning pin 6a or 6b, as well as conveying voltage applying terminals 9a and 9b each having an end connected to the attracting electrode 2a or 2b and another and being exposed from the bottom face of the protrusion 8a or 8b. The positioning pin 6c has no voltage applying terminal inside thereof.

The dielectric material layer 4 constituting the electrostatic chuck 10 may be made of ceramics. Preferably, it may be suitably made of alumina ceramics containing 99 weight percent or more of alumina, or aluminum nitride ceramics containing 99 weight percent or more of aluminum nitride. As regards the material of attracting electrodes 2a and 2b, those materials having a similar thermal expansion coefficient as of the ceramics base member 3 or the ceramics dielectric material layer 4, constituting the electrostatic chuck 10, and having good heat resistance as well. Metal materials such as molybdenum, Kovar, and tungsten, for example, may be used suitably.

Next, the method of attracting an article to be attracted, with this electrostatic chuck, will be explained with reference to FIG. 1.

First, an article 1 to be attracted, such as a wafer, for example, is placed on the holding surface 5 of the electrostatic chuck 10. Then, from a DC voltage source, a positive electric voltage is applied to the first attracting electrode 2a through the chuck side voltage applying terminal 7a, while a negative electric voltage is applied to the second attracting electrode 2b through the chuck side voltage applying terminal 7b. In response, the electrode 2a is charged positively, while the electrode 2b is charged negatively. On the other hand, the portion of the article 1 opposed to the electrode 2a is charged negatively, while the portion of the article 1 opposed to the electrode 2b is charged positively. Thus, an electric potential difference is produced between the article 1 and the electrodes 2a and 2b such that, by means of Coulomb force, the article can be electrostatically attracted to the chuck.

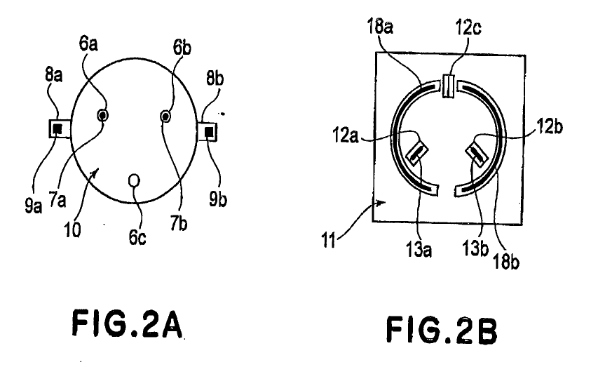

FIGS. 2A and 2B show an example of disposition of pinholes on the stage top surface which function as positioning holes. FIG. 2A is a bottom view of the electrostatic chuck 10 and, as shown, on the bottom surface of the chuck there are three positioning pins 6a, 6b and 6c which are disposed so as not to be aligned along a straight line. FIG. 2B is a plan view Of the stage 11 on which the electrostatic chuck is going to be mounted. The stage 11 has formed on its top surface three conical pinholes 12a, 12b and 12c having inverse triangular sectional shape, which are in engagement relationship with the positioning pins 6a, 6b and 6c of the electrostatic chuck 10, respectively. At the bottom of the pinholes 12a and 12b, there are stage side voltage applying terminals 13a and 13b, respectively. Furthermore, the stage 11 has chuck attracting electrodes 18a and 18b each being embedded on the top surface of the stage and each having an insulating material covering the outer periphery of the electrode.

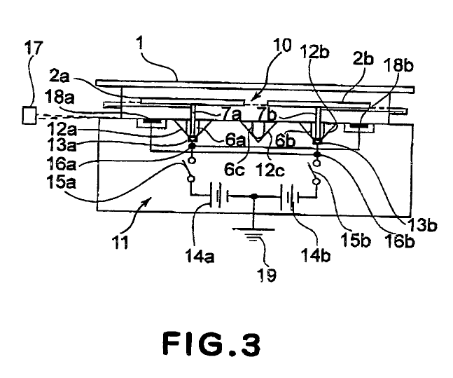

FIG. 3 illustrates the state in which the electrostatic chuck shown in FIGS. 2A and 2B is mounted on the stage 11. The stage 11 includes, inside thereof, DC voltage sources 14a and 14b, selecting switches 15a and 15b for changing the state of voltage supply, and voltage supplying wires 16a and 16b for connecting the stage side voltage applying terminals 13a and 13b with selector switches 15a and 15b. The chuck attracting electrodes 18a and 18b embedded on the top surface of the stage 11 are connected to the voltage supplying wires 16a and 16b, respectively. Here, the DC voltage sources 14a and 14b as well as the selector switches 15a and 15b may be provided outside the stage 11, while extending the voltage supplying wires 16a and 16b.

Next, the power supplying method in the state in which the electrostatic chuck is mounted on the stage as shown in FIG. 3 will be explained.

As the electrostatic chuck 10 having an article 1 such as a wafer, to be attracted, placed thereon is mounted at a predetermined position on the stage 11, the voltage applying terminals 7a and 7b of the positioning pins 6a and 6b are brought into contact with the voltage applying terminals 13a and 13b of the pinholes 12a and 12b, whereby electric conduction is established. At the same time, as the placement of the electrostatic chuck 10 at the predetermined position is detected by a sensor (detecting means) 17, the selector switches 15a and 15b are turned on, such that voltages are applied to the attracting electrodes 2a and 2b from the DC voltage source 14a and 14b through the stage side voltage applying terminals 13a and 13b and chuck side voltage applying terminals 7a and 7b, respectively. In response, an electrostatic attraction force is produced between the article 1 and the electrodes, and thus the article 1 can be held by attraction.

Here, the structure is arranged so that, when the electrostatic chuck 10 is placed accurately at the predetermined position, the bottom surface of the electrostatic chuck 10 and the top surface of the stage 11 are brought into contact with each other. The selector switches 15a and 15b are turned on in response and voltages are supplied to the chuck attracting electrodes 18a and 18b, and one electrode 18a is charged negatively while the other electrode 18b is charged positively. As a result, an attracting force is produced between the chuck and the electrodes 2a and 2b, whereby the electrostatic chuck 10 can be attracted and fixed onto the stage 11 Hence, despite the chuck is mounted on the stage 11 which moves forwardly/backwardly and leftwardly/rightwardly, the electrostatic chuck 10 can be held fixed at the predetermined position.

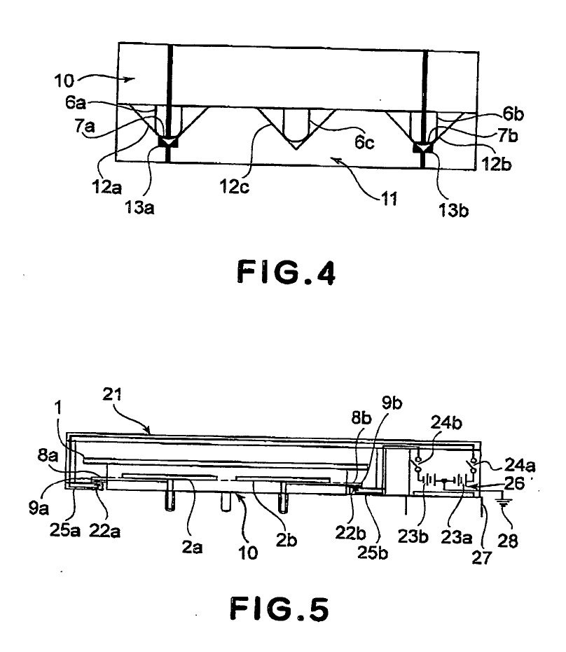

FIG. 4 illustrates the positioning means which functions when the electrostatic chuck is transferred onto the stage top surface. The positioning pins 6a, 6b and 6c having rounded or spherical free ends and the pinholes 12a, 12b and 12c having inverse triangular sectional shape cooperate with each other to structurally constitute a kinematic coupling. When these three pairs of positioning pins 6a-6c and pinholes 12a-12c all engage accurately each other, the position and the plane (tilt) of the electrostatic chuck 10 are determined definitely. The positioning method where the electrostatic chuck 10 is going to be transferred is thus based on the principal of kinematic coupling such as described above, and additionally the structure is arranged to assure that, only when the positioning is accomplished correctly, the stage side voltage applying terminals 13a and 13b are brought into contact the chuck side voltage applying terminals 7a and 7b and also the bottom face of the electrostatic chuck 10 and the top face of the stage 11 are brought into contact with each other

FIG. 5 illustrates the state in which the electrostatic chuck is conveyed by means of a conveying hand. The conveying hand denoted at 21 is movable along a conveying path 27, and it includes hand side voltage applying terminals 22a and 22b which are provided on an upper surface of the free end portions of the hand. There is a movable member 26 being movable along the conveyance path 27 and supporting the conveying hand 21. The movable member 26 includes, inside thereof, conveying DC voltage sources 23a and 23b as well as selecting switches 24a and 24b for changing the stage of voltage supply. The conveying hand 21 includes, inside thereof, conveying voltage supplying wires 25a and 25b for connecting the hand side voltage applying terminals 22a and 22b and the hand side selector switches 24a and 24b. Here, the conveying DC voltage sources 23a and 23b as well as the hand side selector switches 24a and 24b may be provided outside the movable member 26 while extending the conveying voltage supplying wires 25a and 25b.

Next, the method of applying an electric voltage when the electrostatic chuck is conveyed by the conveying hand as shown in FIG. 5 will be explained.

Initially, the electrostatic chuck 10 having an article 1 mounted thereon is lifted up by pushing up the holding protrusions 8a and 8b of the electrostatic chuck 10 by the free end portions of the conveying hand 21. In response, the conveying voltage applying terminals 9a and 9b provided on the lower surfaces of the holding protrusions 8a and 8b are brought into contact with the hand side voltage applying terminals 22a and 22b, respectively, provided on the upper surfaces of the free end portions of the conveying hand 21, whereby electric conduction is established therebetween. Simultaneously with this, the catching of the electrostatic chuck 10 by the conveyance hand 21 is detected by means of an unshown sensor (detecting means) and, in response, the hand side selector switches 24a and 24b are turned on such that electric voltages are supplied to the attracting electrodes 2a and 2b from the conveying DC voltage sources 223a and 23b, respectively, through the hand side voltage applying terminals 22a and 22b as well as the conveying voltage applying terminals 9a and 9b. As a result, an electrostatic attraction force is produced between the article 1 and the electrodes, and the article 1 can be held by attraction.

Thus, in this embodiment, there is no necessity of providing a storage capacitor as well as a selector switch for changing the state of voltage supply, inside the electrostatic chuck 10. The structure of the electrostatic chuck 10 can therefore be simplified and, additionally, the chuck can be conveyed without extending the conveying voltage supplying wires 25a and 25b throughout the entire conveyance path 27. Here, denoted at 19 in FIG. 3 and at 28 in FIG. 5 is a ground earth.

As regards the detecting method for detecting the catching of the electrostatic chuck 10 by the conveying hand 21, an example may be that torque detecting means is provided at the support of the conveying hand 21 of the movable member 26, and the torque value to be produced when the conveying hand catches the electrostatic chuck 10 having an article 1 mounted thereon is determined beforehand by calculation, such that the hand side selector switches 24a and 24b are turned on as the thus determined torque value is detected. Another example may be that the hand side selector switches 24a and 24b are turned on in response to that the conveying hand 21 moves to the position for catching the electrostatic chuck 10. These methods may be used in combination.

### Embodiment 2

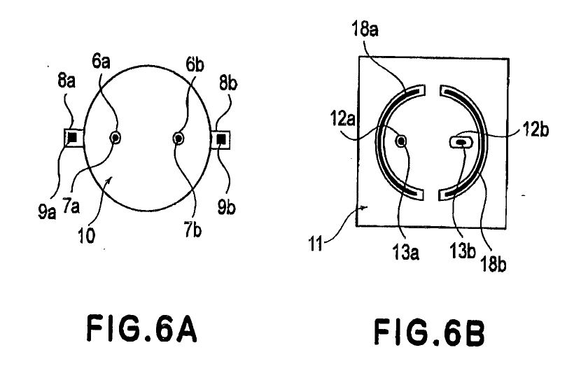

FIGS. 6A and 6B show an electrostatic chuck according to a second embodiment of the present invention, wherein the positioning as the chuck is going to be transferred is accomplished by engagement with two pinholes, one is circular hole and the other is elongated round hole. FIG. 6A is a bottom view of the electrostatic chuck 10 and, as shown, the chuck has two positioning pins 6a and 6b provided at the bottom surface thereof These positioning pins 6a and 6b have chuck side voltage applying terminals 7a and 7b provided at their free end portions. The remaining portion of the electrostatic chuck 10 has a similar structure as of the electrostatic chuck of the first embodiment shown in FIG. 1. FIG. 6B is a plan view of a stage 11 having two pinholes 12a and 12b formed on its top surface, which function as positioning holes. One pinhole 12a has a circular shape, and the other pinhole 12b has an elongated round shape. Mounted at the bottom of the pinholes 12a and 12b are stage side voltage applying terminals 13a and 13b. The remaining portion of the stage 11 has a similar structure as of the stage 11 of the first embodiment shown in FIG. 3.

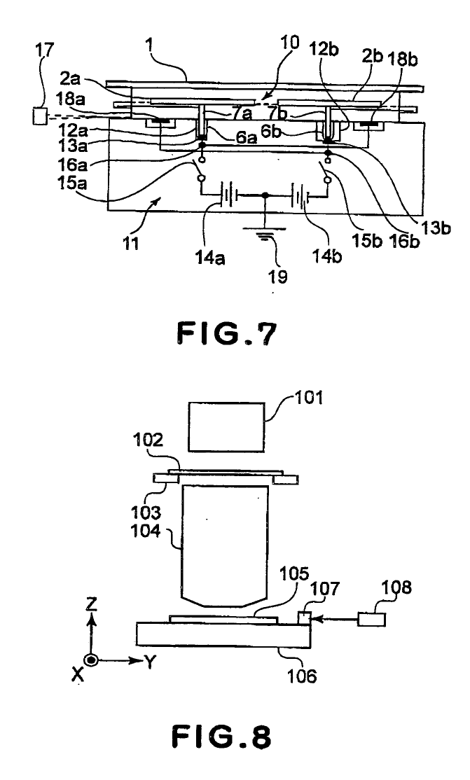

FIG. 7 illustrates the state in which the electrostatic chuck shown in FIGS. 6A and 6B are mounted on the stage. Except for the number and disposition of the positioning pins and for the shape, number and disposition of the pinholes, the structure shown here is similar to that of the electrostatic chuck 10 and the stage 11 of the first embodiment shown in FIG. 2. Furthermore, regarding the voltage supply to the attracting electrodes 2a and 2b as well as the attraction to the electrostatic chuck 10, they are accomplished essentially in the same manner as of the first embodiment shown in FIG. 3.

Next, the positioning method to be carried out when the electrostatic chuck is going to be transferred onto the top surface of the stage will be explained.

The positioning of the electrostatic chuck 10 is accomplished by engagement between the positioning pins 6a and 6b having rounded free ends and the circular and elongated pinholes 12a and 12b formed on the stage 11. More specifically, translating motion of the electrostatic chuck 10 is confined by the engagement between the positioning pin 6a and the circular pinhole 12a, while rotational motion of the electrostatic chuck 10 is confined by the engagement between the positioning pin 6b and the elongated round pinhole 12b. The position of the electrostatic chuck 10 is thus determined. Furthermore, the structure is arranged so that, only when the positioning is accomplished correctly, the stage side voltage applying terminals 13a and 13b are brought into contact with the chuck side voltage applying terminals 7a and 7b and, simultaneously, the bottom face of the electrostatic chuck 10 is brought into contact with the upper surface of the stage 11. The position and the plane (tilt) of the electrostatic chuck is determined in this manner.

### Embodiment 3

FIG. 8 is a schematic view of a general structure of an exposure apparatus 1 for use in the manufacture of semiconductor devices, to which apparatus a positioning system according to the present invention is applied.

In FIG. 8, light emitted from an illumination optical system 101 is projected on a reticle 102 which is an original. The reticle 102 is held on a reticle stage 103, and a pattern of the reticle 102 is projected in a reduced scale corresponding to the magnification of a reduction projection lens 104, whereby an image of the reticle pattern is formed on an image plane of the reduction projection lens 104. The image plane of the reduction projection lens 104 is defined perpendicularly to Z-axis direction. A substrate 105 which is a sample to be exposed has a resist material applied onto its surface, and there may be an array of shots on the surface as formed by preceding exposure process. The substrate which is a controlled object is placed on a stage top plate 106. The stage top plate 106 has a chuck for fixing the substrate 105 as well as an X-Y stage as a driving system being movable in X-axis direction and Y-axis direction. The positional information related to the stage top plate 106 is measured by means of a laser interferometer 108, with reference to a mirror 107 fixedly mounted on the stage top plate 106.

Next, an embodiment of a device manufacturing method which uses an exposure apparatus described above, will be explained.

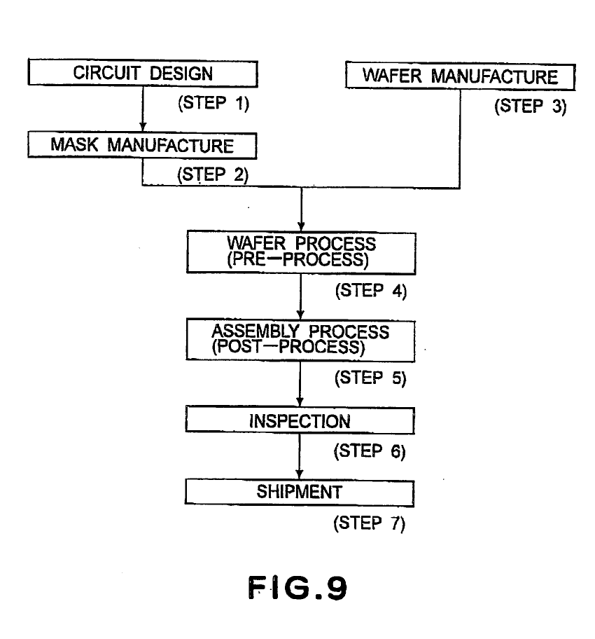

FIG. 9 is a flow chart for explaining the overall procedure for semiconductor manufacture. Step 1 is a design process for designing a circuit of a semiconductor device. Step 2 is a process for making a mask on the basis of the circuit pattern design. Step 3 is a process for preparing a wafer by using a material such as silicon. Step 4 is a wafer process which is called a pre-process wherein, by using the thus prepared mask and wafer, a circuit is formed on the wafer in practice, in accordance with lithography. Step 5 subsequent to this is an assembling step which is called a post-process wherein the wafer having been processed at step 4 is formed into semiconductor chips. This step includes an assembling (dicing and bonding) process and a packaging (chip sealing) process. Step 6 is an inspection step wherein an operation check, a durability check an so on, for the semiconductor devices produced by step 5, are carried out. With these processes, semiconductor devices are produced, and they are shipped (step 7).

More specifically, the wafer process at step 4 described above includes: (i) an oxidation process for oxidizing the surface of a wafer; (ii) a CVD process for forming an insulating film on the wafer surface; (iii) an electrode forming process for forming electrodes upon the wafer by vapor deposition; (iv) an ion implanting process for implanting ions to the wafer; (v) a resist process for applying a resist (photosensitive material) to the wafer; (vi) an exposure process for printing, by exposure, the circuit pattern of the mask on the wafer through the exposure apparatus described above; (vii) a developing process for developing the exposed wafer; (viii) an etching process for removing portions other than the developed resist image; and (ix) a resist separation process for separating the resist material remaining on the wafer after being subjected to the etching process. By repeating these processes, circuit patterns are superposedly formed on the wafer.

The exposure apparatus is not limited to what described above. It may be those to be used for manufacture of microdevices having a fine pattern formed thereon, such as semiconductor devices (semiconductor integrated circuits, for example), micromachines, or thin-film magnetic heads, for example. In this exposure apparatus, exposure light (which may include visible light, ultraviolet light, EUV light, X-ray, electron beam, and charged particle beam, for example) as an exposure energy supplied from a light source may illuminate an original such as a mark or reticle, and light from the original is projected onto a semiconductor wafer W (substrate) through a projection system having a projection lens (which may include refractive lens, reflective lens, catadioptric lens system, and charged particle lens, for example), whereby a desired pattern can be produced on the substrate. Furthermore, it may be an exposure apparatus in which a circuit pattern is directly drawn on a semiconductor wafer without using a mask, to expose the resist thereon.

In accordance with the embodiments of the present invention as described hereinbefore, when an electrostatic chuck is mounted on a stage, an electric voltage is supplied from a DC voltage source at the stage side through a positioning hole and a positioning pin, engaging with the positioning hole. During conveyance, an electric voltage is supplied from a DC voltage source provided in relation to a conveying hand, through a protrusion that holds the electrostatic chuck. Thus, an electric power can be supplied to the electrostatic chuck continuously. Consequently, there is no necessity of providing a storage capacitor as well as a selector switch for changing the state of voltage supply, inside the electrostatic chuck. The structure of the electrostatic chuck can therefore be simplified and, additionally, the chuck can be conveyed without extending conveying voltage supplying wires from the DC voltage source. Furthermore, due to the engagement of the positioning pin of the electrostatic chuck and the pinhole of the stage, the positioning of the chuck can be accomplished accurately and yet easily.

While the invention has been described with reference to the structures disclosed herein, it is not confined to the details set forth and this application is intended to cover such modifications or changes as may come within the purposes of the improvements or the scope of the following claims.

This application claims priority from Japanese Patent Application No. 2004-175590 filed Jun. 14, 2004, for which is hereby incorporated by reference.

1. An electrostatic chuck for holding an object through an electrostatic attraction force, comprising:
an electrode;
a main body including said electrode, said main body having a first surface for holding the object and a second surface different from the first surface;
a protrusion formed on the second surface of said main body; and
a terminal provided on said protrusion, for electric conduction with said electrode.

2. An electrostatic chuck according to claim 1, wherein the second surface of the main body is at an opposite side of the first surface of the main body with respect to said electrode, and wherein said protrusion is a positioning protrusion provided on the second surface of the main body.

3. An electrostatic chuck according to claim 1, wherein the second surface is of the main body is a side surface adjacent to the first surface of the main body, and wherein said protrusion is a conveying protrusion provided on the second surface of the main body.

4. An electrostatic chuck according to claim 2, wherein the positioning protrusion is arranged to provide kinematic coupling in association with a positioning hole provided on a surface of a stage on which said electrostatic chuck is to be mounted.

5. An electrostatic chuck according to claim 4, wherein said chuck include at least two positioning protrusions each being as aforesaid.

6. An apparatus for manufacturing a device, said apparatus comprising:
an electrostatic chuck as recited in claim 1; and
a stage for holding said electrostatic chuck, said stage having a terminal for applying a voltage to a terminal of said electrostatic chuck as recited in claim 1.

7. An apparatus for manufacturing a device, said apparatus comprising:
an electrostatic chuck as recited in claim 1; and
a hand for conveying said electrostatic chuck, said hand having a terminal for applying a voltage to a terminal of said electrostatic chuck as recited in claim 1.

8. A method of manufacturing a device, said method comprising steps of:
holding an object by use of an electrostatic chuck as recited in claim 1; and
processing the object held by the electrostatic chuck, for production of the device.
